(19) United States
(12) Patent Application Publication
(10) Pub. No.: US 2016/0125288 A1
(43) Pub. Date: May 5, 2016

(54) Physically Unclonable Functions Using Neuromorphic Networks

(71) Applicant: CARNEGIE MELLON UNIVERSITY, a Pennsylvania Non-Profit Corporation, Pittsburgh, PA (US)

(72) Inventors: Lawrence Thomas Pileggi, Pittsburgh, PA (US); Abhishek Anil Sharma, Pittsburgh, PA (US); Thomas Christopher Jackson, Pittsburgh, PA (US); Jeffrey Arthur Weldon, Pittsburgh, PA (US)

(73) Assignee: CARNEGIE MELLON UNIVERSITY, a Pennsylvania Non-Profit Corporation, Pittsburgh, PA (US)

(21) Appl. No.: 14/931,592

(22) Filed: Nov. 3, 2015

Related U.S. Application Data
(60) Provisional application No. 62/122,964, filed on Nov. 3, 2014.

(51) Int. Cl. G06N 3/04; G06F 21/44

(52) U.S. Cl. CPC G06N 3/04; G06F 21/44

(57) ABSTRACT

The disclosure describes the use of a neural network circuit, such as an oscillatory neural network or cellular neural network, to serve as a physically unclonable function on an integrated circuit or within an electronic system. The manufacturing process variations that impact the initial state of the neural network parameters are used to provide the unique identification for the physically unclonable function. A challenge signal to the neural network results in a response that is unique to the circuits process variations. The neural network is designed such that there are random variations among manufactured circuits, but that the specific instance variations are sufficiently deterministic with respect to circuit aging and environmental conditions such as temperature and supply voltage.

### CROSS-REFERENCE TO RELATED APPLICATIONS

This application claims the benefit under 35 U.S.C. §119 of Provisional Ser. No. 62/122,964, filed Nov. 3, 2014, which is incorporated herein by reference.

### STATEMENT REGARDING FEDERALLY SPONSORED RESEARCH

This invention was made with government funds under Agreement No. HR0011-13-3-0002 awarded by DARPA. The U.S. Government has rights in this invention.

### BACKGROUND OF THE INVENTION

The invention relates generally to physically unclonable functions. More specifically, the invention relates to a neuromorphic network that can be used for creating a physically unclonable function.

The human brain is a powerful computing system that performs information processing quite efficiently via its massively parallel neural mechanism. Analog Neural Networks (ANNs) attempt to mimic this neural mechanism in the human brain in order to overcome some bottlenecks of the traditional von Neumann machines, especially for computationally-intensive applications such as image processing and pattern recognition.

The Cellular Neural Network (CNN) that was first proposed by L. O. Chua and L. Yang in 1988 is a special class of ANNs as it offers only local interconnections among the artificial neurons. Regardless of the number of neurons in the CNN system, each neuron is connected to only the neighboring neurons within a specified radius r and itself. For example, referring to a two-dimensional CNN architecture shown in FIG. 1, for r=1 the cell in the center interacts only with the eight immediately adjacent cells and itself, whereas it interacts with the sixteen cells as well for r=2. This radius can be extended for better accuracy such that all neurons share one-to-one connections like the other ANN systems, but CNNs can be built for more efficient hardware implementations using the smallest possible radius that corresponds to only 9 connections for each neuron.

Recently, heterogeneous devices and materials have been proposed and implemented as electronic synapses. Of particular interest has been RRAM, which offers non-volatility for such devices. The voltage-controlled resistances that remain the same even when powered off are adjusted to have programmable synaptic weights. Some proposals have also been made for creating neural networks using other types of emerging devices and materials, such as aluminum nitride and magnetics.

Further inspired by the oscillatory nature of some brain sub-systems, others have proposed an Oscillatory Neural Network (ONN) architecture based on coupling phase-locked loops (PLLs) in a network. A single cell of this network is shown conceptually in FIG. 2. In the parlance of neuromorphic computing, the PLL acts as the “neuron,” integrating and storing the state of the system as its phase while the connections act as the “synapses,” or the weighted influence of one neuron on another. It has been shown that in this style of network, the neurons all synchronize to the same frequency and that their relative phases settle to a pattern stored in the network.

$$τ \frac{d {x}_{c}}{d t} = - g ( {x}_{c} ( t ) ) + {\sum }_{d ∈ N ( c )} {a}_{c , d} \cdot {y}_{d} ( t ) + {u}_{c} \qquad ( 1 )$$

Equation 1 is the state space definition of a neuromorphic network. The state of the network is given by x_{c}, the output from each neighbor is given by y_{d}, the weight between the neurons of the system is given by a_{c,d}, and the input to the cell is given by u_{c}. Since it is a dynamical system, the initial condition x_{c}(0) will affect the final settled value of x_{c}(t).

ONNs and CNNs are implementations of the same fundamental state-space equation, given in Equation 1. This state space maps an input vector of length N to an output vector of length N, where N is the number of neurons in the network. The input can be provided by either forcing an initial condition or by providing an input into the summation. The system is then allowed to converge to the closest energy minimum which is defined by the synaptic weights. When using them as an associative memory, these minima are defined by the training the values of the synapses that define the connectivity between neurons.

If, on the other hand, the weights and initial conditions are not explicitly set by the user, the energy landscape would be defined by process variations. Therefore, the system has a set of patterns stored in it upon fabrication, and these patterns are randomly determined by the variability during manufacturing. This variability can be exploited for use as a Physically Unclonable Function (PUF).

PUFs are a method of using intrinsic random physical features of an instance of a chip for the purpose of simple counterfeit detection or as the seed for more complex cryptographic functions. PUFs leverage uncontrollable physical die-to-die variation in integrated circuit (IC) manufacturing to generate unique identifiers, meaning a single mask can be used to generate a large number of chips that can uniquely identify themselves. Unlike a simple ID code, however, a PUF is a function--namely it returns a uniquely identifiable output (or response) in response to an input (or challenge).

However, CMOS-based PUFs suffer from inconsistencies over a range of temperatures and voltages. In addition, some architectures, such as arbiters and ring oscillators, can be vulnerable to attack. In such an attack, a PUF challenge response could be predicted based on a subset of known responses. One key in a strong PUF is that the physical secret should be prohibitively difficult to predict after modeling. An attractive quality of using a neural network as the function to produce an output based on the physical secret is the non-linear nature of the network will obfuscate the initial conditions and random parameters. The number of connections in a large network makes an attempt to learn the system through a modeling attack prohibitive, if not impossible. This is unlike simpler delay-based arbiters or ring oscillator PUF designs. The neural network-based PUF will not need additional circuitry to attempt to obfuscate the secret further.

It would therefore be advantageous to develop an architecture that can be used as a PUF, but that does not suffer from the drawbacks of PUFs created from traditional CMOS-based devices.

### BRIEF SUMMARY OF THE INVENTION

According to embodiments of the present disclosure is a neuromorphic network that can function as a PUF. The randomness of the initial state and conditions of the artificial neurons and/or synapses represent a unique identifier for the manufactured IC. If truly random, then no two ICs would have the exact same initial state or conditions for large enough analog neural networks. This variability is the fundamental feature needed to construct a PUF for secure IC applications.

In one embodiment of the present invention, the circuitry of the neuromorphic network is similar to that used in an ONN or CNN to perform the PUF function. More specifically, in one embodiment the neuromorphic network consists of a plurality of interconnected nodes, or artificial neurons, where the weighted outputs of several nodes in a first layer are summed and used as the input of a second layer node. An input to the network will represent a “challenge” that will receive a “response” based on the random initial state and conditions of the network. To function as a PUF, the system relies on the initial state being truly random from die-to-die to distinguish one IC from another, while being consistent for repeated queries on a single die. This unclonable random initial state must remain consistent for all product aging and environmental conditions. Most importantly, the design of the neural network can be structured to accommodate some small perturbations with aging. For example, consider one embodiment in which an ONN based on oscillators is used for neurons and programmable resistances are used for synapses, whereby the stored information is the total phase shifts among the oscillators upon startup. Since the response to any challenge is an aggregate response due to the phase relationships among all of the artificial neurons, small shifts in the initial phase states relative to neighboring neuron phases will have only a limited impact on the overall response. This is due to the inherent nature of neural networks that perform their computation based on imprecise data.

### BRIEF DESCRIPTION OF THE SEVERAL VIEWS OF THE DRAWINGS

FIG. 1 shows a two-dimensional CNN illustrating the neighboring cells for a CNN cell when r=1.

FIG. 2 is a diagram depicting a cell of a neural network where the cell is an analog processing element.

FIG. 3 is a diagram depicting an example of a cell of an Oscillatory Neural Network (ONN).

FIG. 4 illustrates one cell of a network, according to one embodiment, where the oscillator is implemented using RRAM devices.

FIG. 5 is a high-level schematic of the network showing multiple neurons, where the state of the network is stored as the values of the various φ(t).

FIG. 6 is a graph showing negative differential resistance behavior of a neuron, according to one embodiment, as it undergoes bifurcation.

FIG. 7A is a graph showing voltage and current oscillations in the neuron.

FIG. 7B is a diagram of the circuit parasitics loading the measurement setup.

FIG. 8A is a graph showing a phase portrait of the oscillations in the I-V plane.

FIG. 8B is a flowchart representing the filament formation and dissolution in a neuron that gives rise to oscillations.

FIGS. 9A-9C are graphs showing cycle to cycle for 10 cycles (FIG. 9A) and device to device (FIG. 9B) variability in incubation times for 20 devices, with the variability shown in a histogram (FIG. 9C).

FIG. 10 is a graph showing three devices undergoing oscillations with different incubation times.

FIG. 11 is a graph showing frequency tuning with a transistor ballast, with parasitics and extra loading also shown; also shown in the inset is an image of the 1T1R device and a tunneling electron microscope micrograph of amorphous TaOx.

FIG. 12 is another graph showing frequency tuning with a transistor ballast.

FIG. 13 is a flowchart of the method of performing physically unclonable functions using neuromorphic networks, according to one embodiment.

FIGS. 14A-14B are a pair of graphs showing two instantiations of an 8-neuron NN-based PUF. The two PUFs have the same initial condition but random synaptic weights. Given the same initialization, they settle to different output values. The y-axis is total phase, the equivalent modulo 360 degree phase is included for clarity.

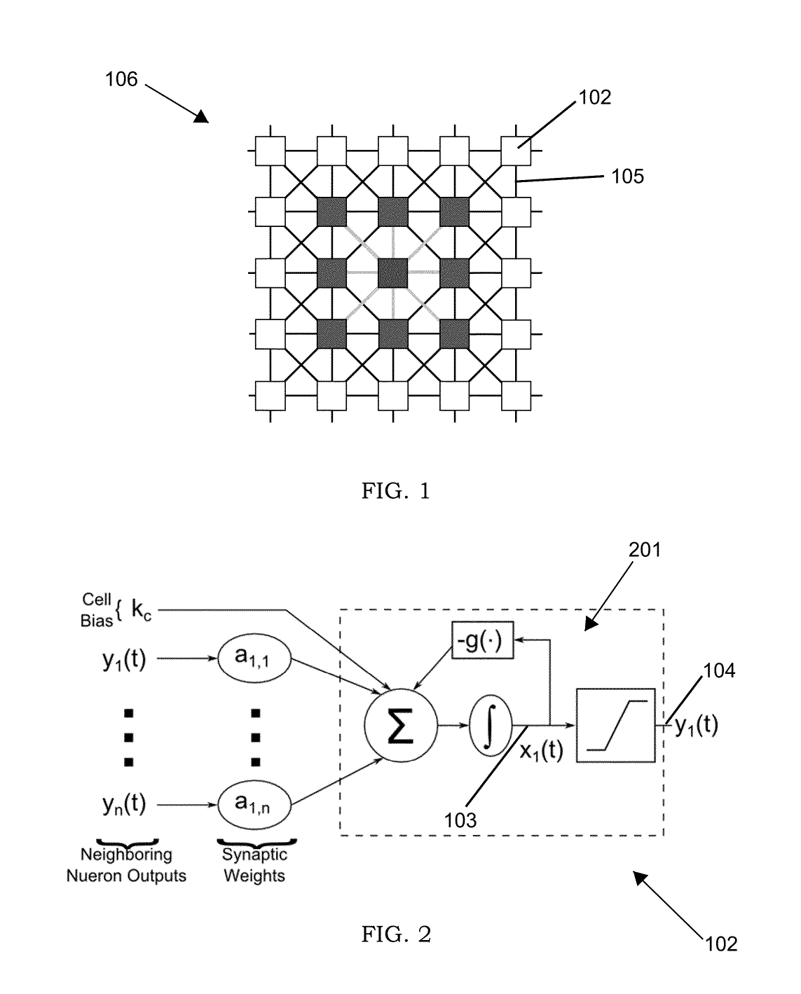

### DETAILED DESCRIPTION OF THE INVENTION

Embodiments of the present invention and its advantages are best understood by referring to the figures. FIG. 2 shows a cell of a neural network 106 according to one embodiment, where the neuron 102 comprises an analog processing element 201. Each cell has an input 103 and an output 104. The input 103 is comprised of the weighted sum of the output of all neighboring neurons 102 connected by synapses 105. In this particular embodiment, the values of the input 103 (shown as X₁) and the output (shown as Y₁) can be any analog value such as current, voltage, or some other physical quantity. In an Oscillatory Neural Network (ONN), the value of the input 103 and output 104 is the phase of the oscillator 301.

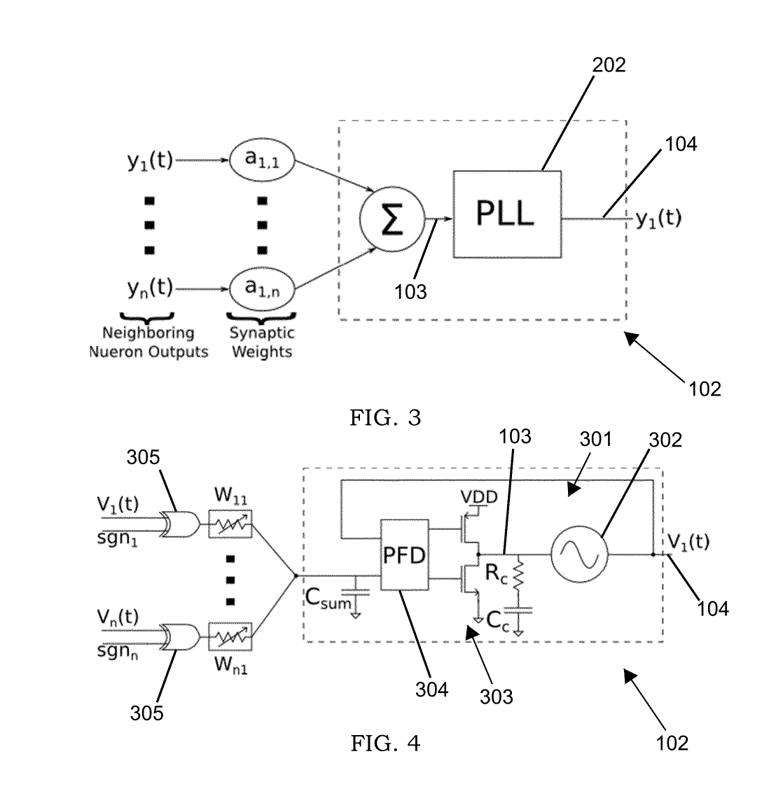

FIG. 3 shows, in general, an ONN where information in the system is stored as the phase of the output signals of each of the phase-locked loops (PLLs) 202. In terms of a neural network 106, the neuron 102 comprises the PLL 202 and the synapses 105 are the connections between the PLL 202 and neighboring neuron outputs 104. In a preferred embodiment of the present invention, the neuron 102 is implemented as a PLL 202 built around devices showing S-type negative differential resistance (S-NDR) behavior. These phase-change or oxide-based devices are used as nano-oscillators which store the state of the system.

A schematic showing a single cell, or neuron 102, of the network 106 according to the preferred embodiment is shown in FIG. 4. As shown in FIG. 4, the neuron 102 is a nano-oscillator 301 comprising a RRAM cell 302 in series with a PMOS transistor 303. The phase of each oscillator 301 is locked to a weighted sum of the phases of neighboring neurons 102. The resistance values of Wₗ₁ to Wₙ₁ are the values of the synaptic weights. In this particular embodiment, the weighted sum signal is measured with a phase-frequency detector (PFD) 304, which uses digital circuitry to convert the phase difference into a voltage to drive the voltage controlled oscillator 301. As further shown in FIG. 4, XOR logic gates 305 on the left side of the neuron 102 provide the sign inversion needed for some weights in the network 106.

The state of the network 106 is stored as the relative phase between the oscillators 301, and therefore the input vector will be a waveform of phase 0 or 180 degrees. The output vector is generated by measuring the phase of each neuron 102 relative to a reference neuron 102, and thresholding them to be either 0 or 180 degrees. Thresholding is used in the preferred embodiment because the phase settles quickly to a value near 0 or 180, but complete settling takes a longer period of time. For example, if the phase of a neuron 102 settles to 2, then the thresholding step would cause the phase to be indicated as 0, since the phase is more likely to completely settle to 0 than 180.

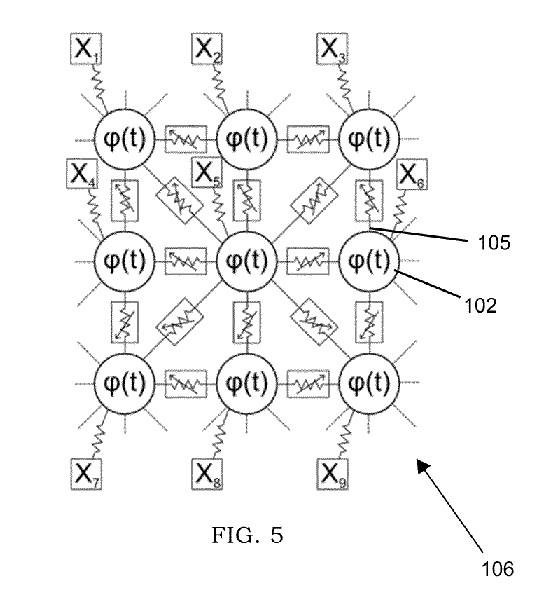

The physical randomness needed for the PUF comes from the randomization of the initial condition of the network 106, which is based on the initial phase of the individual oscillators 301 comprising the network 106. For example, FIG. 5 shows a high-level schematic of a neural network 106 showing multiple neurons 102 in a cellular connectivity pattern. The state of the network 106 is stored as the values of the various phases of the individual neurons 102, shown in FIG. 5 as φ(t). The bits, that can be the challenge to the PUF in some embodiments of the invention, are input at each neuron 102 and are represented by Xᵢ. The response of the PUF to the challenge is the equilibrium achieved by the network 106. Stated differently, the response to a challenge of any individual neuron 102 is affected by the phase of connected neurons 102, which is dependent on its initial condition. Because the initial condition results from the incubation time of the oscillator 301 (i.e. time for the oscillator 301 to begin oscillating), each neuron 102 will have a different initial condition. Consequently, the randomization of the initial condition of the network 106—determined by the incubation time of the oscillators 301—is the variability needed to implement the PUF.

As previously indicated, the oscillators 301 used in the preferred embodiment are based on devices exhibiting S-NDR behavior. This behavior is seen in transition metal oxides and chalcogenide-based phase change materials (also known as threshold switches). It has been widely known that disordered glasses (including polycrystalline films with defects) like chalcogenides and some transition metal oxides show a characteristic bistability in their resistance states. As an example of one such device, Ta₂O₅₋ₓ devices exhibit transient and reversible localization of current; thus, this material can be used as an S-type NDR device.

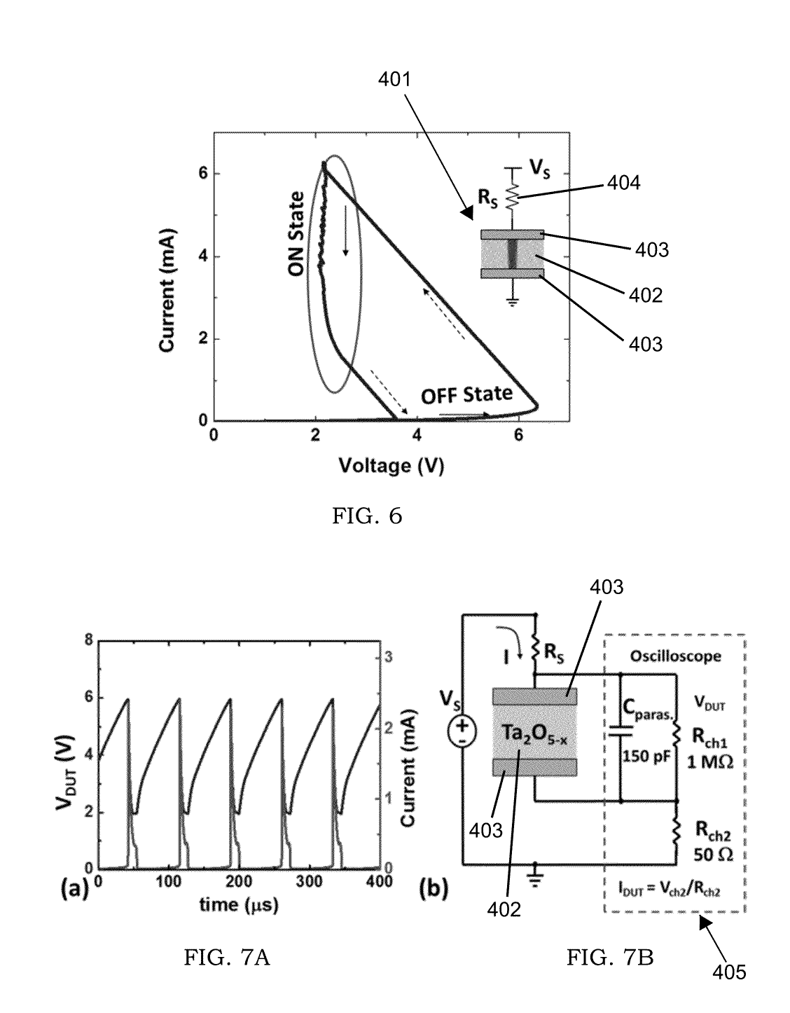

The negative differential resistance observed in a transition metal oxide material can be utilized as an oscillatory element. The oscillatory element comprises a dielectric material 402 placed between two electrodes 403, which is shown in the inset of FIG. 6. In one particular embodiment, transition metal oxide based devices 401 are fabricated with 700 nm vertical crossbars consisting of 40 nm of TaOₓ as the dielectric material 402 sandwiched between Ta (2 nm)/Pt (10 nm) and Pt (10 nm) electrodes 403. Devices 401 with a TiO₂ based stack can also be used, with the choice of material dependent on factors such as tunability and scalability of these oscillators 301. Change in the device operation in terms of operation voltage and temporal dynamics can be brought about by changing the thickness, electrode material and thermal properties.

FIG. 6 shows the circuit schematic of a Ta₂O₅, device 401 connected in series with a 21 kΩ resistor 404. The accompanying graph of FIG. 6 depicts the negative differential resistance behavior of the device 401. This behavior results from a unique property of transition metal oxide devices which enables the current flowing uniformly through the device 401 to spontaneously and reversibly collapse into a narrow electronic filament, known as a “bifurcation” phenomenon. As the bias across the device-resistance pair is slowly increased (0.1 V/ms), the current through the device 401 increases and eventually, at a threshold voltage, the device 401 enters into the negative differential resistance regime. The threshold voltage is the voltage of the device 401 required to form the temporary electronic filament within the dielectric layer 402, causing a reduction in resistance and a drop in voltage. When the device 401 forms a conductive filament as it enters NDR, this abrupt reduction in resistance is responsible for causing the differential resistance to go negative.

To prevent current runaway and permanent changes in the device 401, a series resistance is added in the circuit path. Depending on the over-voltage (differential voltage beyond the threshold voltage) applied to the device 401, the device 401 may settle down to various low resistance states, or ON states. The ON state is completely volatile (corresponding to volatile filament) and the device would revert back to the OFF state (filament dissolved) once the field is removed. The voltage and current associated with this reversal is termed as holding voltage and current.

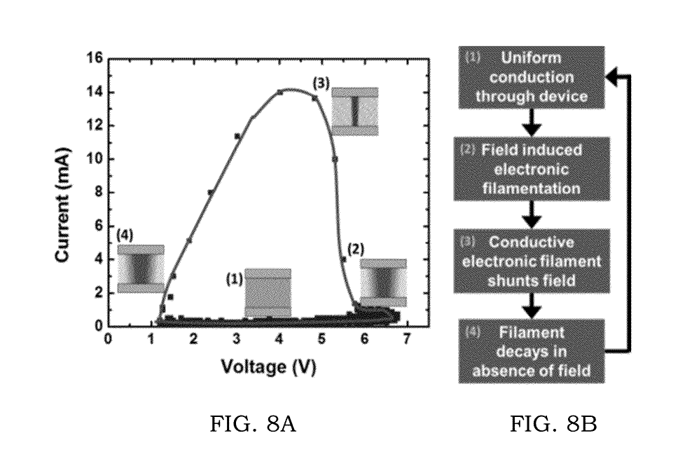

Once the device 401 switches to ON state (i.e. temporary filament formed and temporary low resistance state), the resistance of the device 401 experiences a rapid decrease. Due to the voltage division enforced by the resistance in series, the voltage across the device 401 drops. This drives the device 401 to an I-V point in the ON state that is lower than the holding voltages and current. Thus the electronic filament is unstable and dissolves, driving the device 401 back to the OFF state. Once in high resistance state, the voltage across the device 401 starts increasing, eventually beyond the threshold voltage which causes the device 401 to go back to the ON state. This process repeats itself resulting in self-sustained oscillations, as shown in FIG. 7A. FIG. 7B shows the testing circuitry 405 associated with the device 401, which can be used for testing purposes. The phase portrait of these oscillations can be plotted as shown in FIG. 8A and shows a clear separation of the low (˜300Ω) and the high resistance states (100 kΩ). FIG. 8B shows the stages of the device 401 at various points on the graph in FIG. 8A. For example, at point (1), the device is uniformly conducting electricity. As the voltage increases, filed induced electronic filamentation occurs at point (2). The conductive filament shunts the field at point (3), eventually leading to the decay of the filament in the absence of a field at point (4).

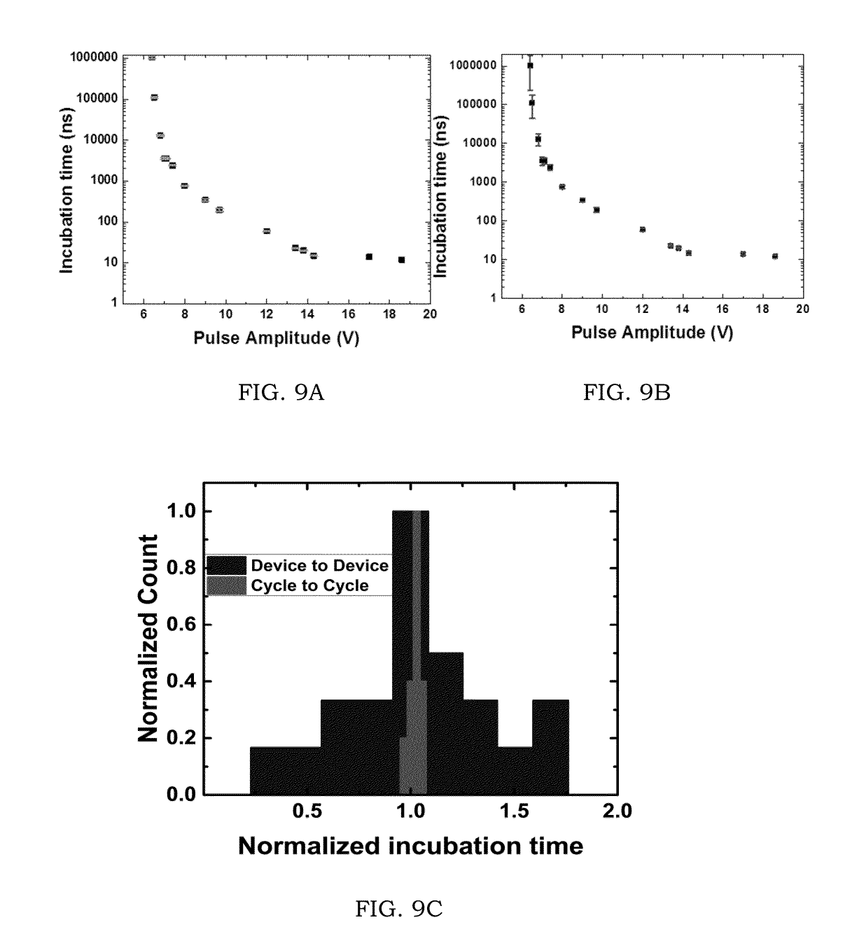

Despite the device 401 being stressed with a certain applied voltage beyond the threshold voltage, it takes a well-defined incubation time before the oscillations start. This sets an initial phase offset that propagates through the oscillations and thus sets the initial conditions for the PUF. In other words, any two devices 401 with different incubation times (delay) will result in those two oscillators having two dissimilar phases. It must be noted that a range of voltages can be used to initiate oscillations and the incubation time associated with these voltages can be tuned, as shown in FIG. 9A. The same device 401 has a very tight distribution associated with the incubation time for the oscillations. However, device to device variability of the incubation time is much larger, as captured in FIGS. 9A and 9B. The deviation from the mean is <2% for the same device 401 when the oscillations are initiated. However, a much larger spread of more than 70% is seen due to device 401 to device 401 variation. This incubation time sets the initial phase of the devices 401 and this delay tracks throughout the oscillation cycles. FIG. 9C is a histogram demonstrating the variability.

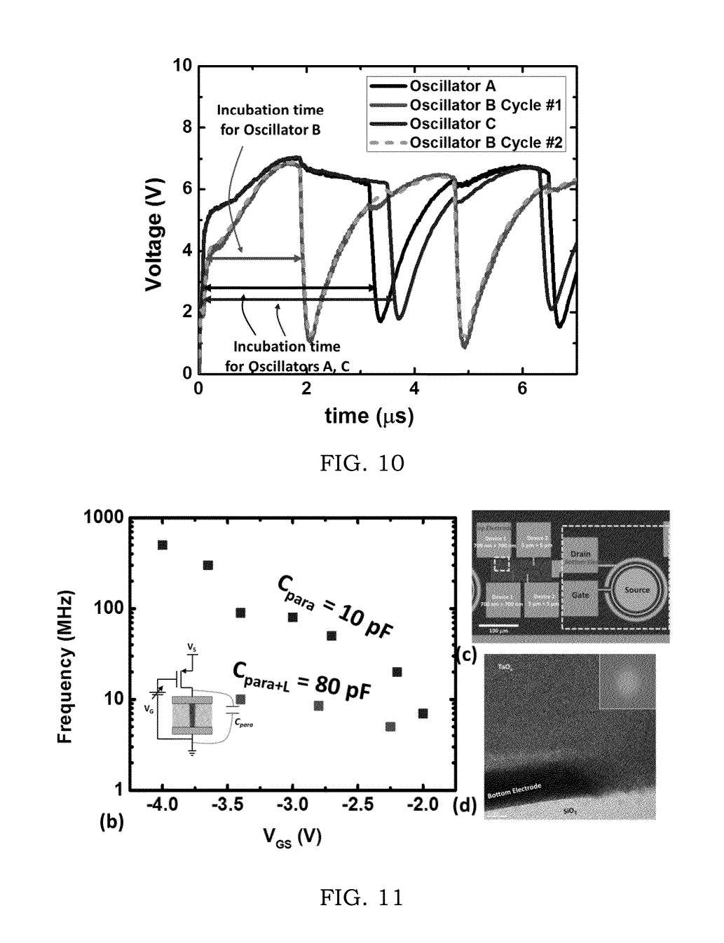

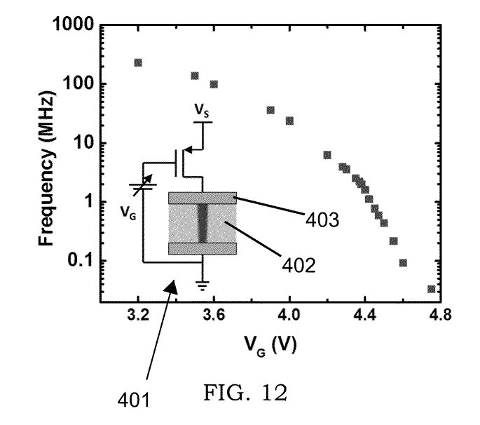

FIG. 10 shows three devices 401 undergoing oscillations at the same frequency but with a phase that is preset by the incubation times of 3.3 μs, 2 μs and 3.7 μs. Individual devices 401 have a consistent incubation period, but the incubation varies from device 401 to device 401, providing the type of randomness needed for the PUF. FIG. 11 shows frequency tuning with a transistor ballast with parasitics (top data points) and extra loading (bottom data points). The inset on the top right of FIG. 11 is an image of the 1T1R device 401. The inset on the bottom right of FIG. 11 is amorphous TaOₓ device 401, as seen in the tunneling electron microscope micrograph with FFT of the image in the inset. Amorphous microstructure is the origin of distribution in nucleation times and thus the initial phase. FIG. 12 is another graph showing frequency tuning of a device 401 with a transistor ballast, such circuitry shown in the inset of the graph in FIG. 12.

Previously, nucleation theory has been looked at as a tool to analyze this incubation time in phase change materials. Nucleation theory defines a critical radius that any phase should reach before it is stabilized. When the field is applied to the device, the material may have small crystallites in an amorphous matrix corresponding to a conducting phase. However, the radius of these crystallites is very small compared to the critical radius needed for sustained stabilization of the conductive phase. Upon exposing the device to a field for a certain incubation time, the nucleus grows in a manner that creates a cylindrical conductive phase that shunts the field through the device. This incubation time is followed by a rapid decrease in resistance known as threshold switching and subsequently oscillations. During this rapid decrease in the resistance of the device 401, the filament is formed through the device thickness. The nucleation theory predicts that the incubation time should be a function of field and temperature and should be governed by the following equation:

$$τ = {τ}_{0} exp ( \frac{{W}_{0}}{kT} \frac{\tilde{V}}{V} ) when V > \tilde{V} .$$

Here, τ is the incubation time, τ₀ to is the pre-exponential factor (often defined as the inverse of attempt frequency), W₀ is the activation energy, k is the Boltzmann's constant, T is the temperature in K, V˜ is the voltage acceleration pre-factor and V is the applied voltage to initiate oscillations. Thus, the incubation time is a strong function of the field dependent activation energy and the attempt frequency. Variability in τ₀ to represents how many growth attempts it takes at different sub-critical nuclear sites before one of those sub-critical nuclei start growing to form the filament. These sub-critical nuclei are usually the defects in a certain device 401 that are a result of process conditions that a particular device experienced. Thus the defect distribution for a single device 401 is preset while it is impossible for two devices 401 to have the same defect distribution. Thus, different devices 401 have a different attempt frequency and thus a different incubation time. The second source of variability is from the activation energy which has an intrinsic distribution that depends not only on the number of defect sites, but also the orientation of the defect sites through the thickness. Similarly, due to localized conduction through this stochastically grown filament experiences different temperatures depending on the defect orientation (straight versus oblique or irregular filament). Thus, the thermal environment is nearly unique to a single device 401 (reducing cycle to cycle variation) but different devices 401 can have different preferred path shapes and resistances. Moreover, these factors affect the incubation time exponentially and thus there is usually a magnified effect of device 401 to device 401 variability due to variation in defect shape, size, orientation and concentration. Also, the incubation time (initial phase for the PUF) is relatively independent of temperature.

The main advantages of this oscillator 301 of this type are: (1) Compact size due to the filamentary nature of the oscillations. (2) Large dynamic change in the voltage during oscillations that can drive other loads, as opposed to other nano-oscillators like spin torque oscillators. (3) Low temperature coefficient of resistance due to the physical mechanism involving a very high-temperature process. (4) Frequency tunability over four orders of magnitude with a ballast device as shown in FIGS. 11 and 12. (5) BEOL CMOS compatibility allows monolithic integration for an area efficient system.

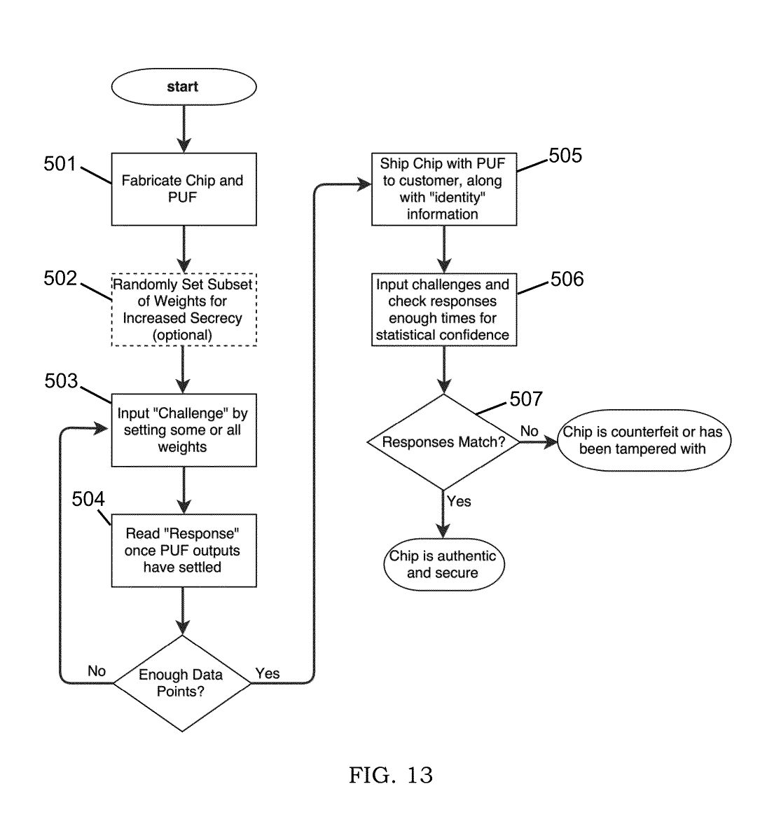

The method of performing a physically unclonable function using a neural network 106, according to one embodiment, is depicted in the flowchart as shown in FIG. 13. More specifically, FIG. 13 shows a method that can be used by a manufacturer to authenticate its chip. For example, at step 501, the manufacturer fabricates a neural network 106, which comprises a chip that incorporates an analog processing element 201 and a plurality of additional analog processing elements 201 connected to the first analog processing element 201. As previously discussed, the analog processing element 201 can comprise an oscillator 301, such as the transition metal oxide-based device 401. At step 502, the manufacturer can set a subset of weights if it wants to increase the secrecy of the PUF. Before the chip is shipped to a customer, the manufacturer inputs a challenge at step 503, where the challenge is the weight of some or all of the outputs 104. Once the neurons 102 have settled, the response is read at step 504. If enough data points are obtained to accurately identify the chip, the manufacturer will ship the chip to a customer at step 505. If not, the challenge can be repeated by the manufacturer before shipping. Once received, the customer can then input a challenge at step 506. The response generated by the customer is confirmed with the manufacturer at step 507. If the response matches the response initially observed by the manufacturer, then the chip is authenticated. If the response does not match, then the chip is not secure.

As previously discussed, the user inputs a configuration of weight patterns as the challenge. This could be done through a digital interface, and will depend precisely on how the weights are implemented. To reduce the possible input space (infinite in the case of analog weights), constraints can be set on the number of weight choices that are possible. The system would then be evaluated, and due to the dynamics of neural networks will settle to each neuron either being a “1” or a “0” based on the weights and the secret initial condition.

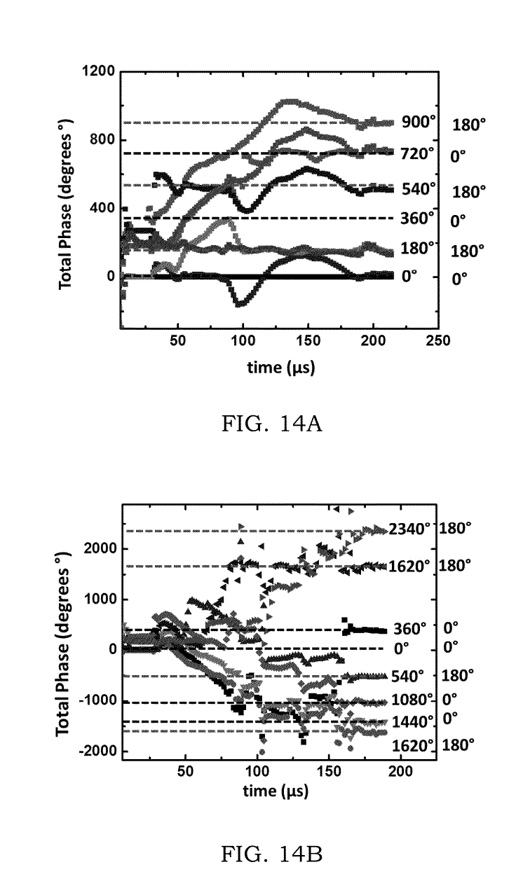

The secret stored in the neural network-based PUF could be in either randomized weights between the neurons 102 of the network 106 or in randomized initial conditions. The randomized weights could be achieved through the stochastic nature of switching RRAM. A simulated example of this method of PUF generation is given in FIGS. 14A and 14B. In this simulation, two 8-neuron example networks 106 are generated with random synaptic connection weights (either strong or weak). They are given the same initial conditions (challenge) and come to different responses. The first PUF returns 00111001 while the second PUF returns 01110010.

This is a small example PUF. Given a much larger neural network 106, it becomes infeasible to attempt to divine the resistance values based only on the input pattern and final settled state due to the complexity of the system. To further increase the randomness of the system, the initial conditions of the neurons 102 are randomized due to process variation as described above. This system defends against modeling attacks by not providing the raw waveforms at the output, but rather whether the final settled phases are in or out of phase with the reference neuron 102. Physical attacks are prevented by the scaling of the RRAM devices 401 to a size where they cannot be probed. Even if physical probing were possible, doing so would introduce defects into the devices (as discussed above), which would change their initial phase, making the system tamper proof.

While the disclosure has been described in detail and with reference to specific embodiments thereof, it will be apparent to one skilled in the art that various changes and modification can be made therein without departing from the spirit and scope of the embodiments. Thus, it is intended that the present disclosure cover the modifications and variations of this disclosure provided they come within the scope of the appended claims and their equivalents.

What is claimed is:

1. A method of performing a physically unclonable function using a neuromorphic network, the method comprising:
providing a neuromorphic network, the network comprising:
a plurality of artificial neurons having an input and at least one output, wherein each neuron of the plurality of artificial neurons comprises an analog processing element;
a plurality of artificial synapses interconnecting the input of each artificial neuron to a plurality of outputs, wherein each neuron of the plurality of artificial neurons is connected to at least one different neuron;
a plurality of circuits connected to each output, wherein each circuit of the plurality of circuits sets the weight of each output to which it is connected;
wherein a response of each neuron is based on a weighted sum of the plurality of outputs connected to each input;
applying a challenge comprising a weighted value for each of the outputs;
determining a response of the neuromorphic network in response to the challenge.

2. The method of claim 1, further comprising:
comparing the response of the neuromorphic network to a response from a previously applied challenge; and
authenticating the neuromorphic network if the response matches the response from the previously applied challenge.

3. The method of claim 1, wherein the analog processing element comprises an oscillator.

4. The method of claim 3, wherein the oscillator is a device exhibiting S-type negative differential resistance behavior.

5. The method of claim 1:
wherein the oscillator is a voltage controlled oscillator; and
wherein the plurality of circuits comprise programmable nonvolatile resistors.

6. The method of claim 5, wherein the voltage controlled oscillator is a RRAM-based oscillator.

7. The method of claim 6, wherein the RRAM-based oscillator comprises:
an RRAM cell; and
a PMOS transistor in series with the RRAM cell.

8. The method of claim 3, wherein the neuromorphic network further comprises a phase-frequency detector.

9. The method of claim 3, wherein the response is a phase of the oscillator.

10. The method of claim 9, further comprising:
thresholding the phase of the oscillator after a period of time.

11. The method of claim 1, wherein the response is the voltage of the analog processing element.

12. The method of claim 1, wherein the response is the current of the analog processing element.
